(19) United States
(12) Patent Application Publication
(10) Pub. No.: US 2026/0112167 A1
(43) Pub. Date: Apr. 23, 2026

(54) SYSTEM AND METHOD FOR SMART MEMORY RECAP OF WATCHED DVR/LIVE CONTENT

(71) Applicant: DISH Network Technologies India Private Limited, Bangalore (IN)

(72) Inventor: Shreyansh Divya, Bengalura (IN)

(21) Appl. No.: 18/921,758

(22) Filed: Oct. 21, 2024

(51) Int. Cl. G06V 20/40; H04N 21/8549

(52) U.S. Cl. CPC G06V 20/47; H04N 21/8549

(57) ABSTRACT

A method for customized smart memory recap for viewed content is disclosed. The method includes: receiving input content into the system through integration with a content delivery system; processing, via a content recognition engine, one or more of metadata, captions, and video/audio feeds associated with the input content to determine significant scenes; extracting, via the content recognition engine, data from the input content associated with the significant scenes; identifying and tagging, via a key moments extraction module, key moments in the significant scenes in the input content; compiling, via a summary generation engine, a summary recap using tagged key moments associated with the significant scenes; customizing, via the personalization module, the summary recap based on user data collected from user input while viewing the input content, and outputting, via a delivery system, the customized summary recap to the user.

### BACKGROUND

There is a growing tread of broadcast, recorded, streaming, and on-demand programming content becoming increasingly complex and intricate with respect to plot line, subject matter, and the like. Additionally, due to filming challenges and other scheduling issues, more and more television series are having increasingly long time periods between seasons. This results in difficulty for viewers to remember all of the necessary information from previous episodes or seasons that is needed to fully understand and appreciate the currently released episodes or other content format.

Furthermore, users often watch a variety of content, which can make it even more difficult to remember multiple different story lines and details, all at the same time. In this regard, it can be time-consuming to manually recall and discuss highlights with friends or family, let alone remember the plot points well enough to enjoyably follow a program. There is a desire among viewers to have some way to recall important intricacies of previously viewed content. Additionally, however, the highlights or plot points that are important to one viewer may not be the same highlights or plot points that are important to another viewer.

Accordingly, there is a continuing need for a system that provides enhanced recall capabilities of previously viewed content. The present disclosure addresses this and other needs.

### BRIEF SUMMARY

The present disclosure generally relates to a system and methods for smart memory recap, and particularly, to a system and methods for customized smart memory recap for viewed content.

Briefly stated, one or more methods for customized smart memory recap for viewed content are disclosed. The method includes: receiving input content into the system through integration with a content delivery system; processing, via a content recognition engine, one or more of metadata, captions, and video/audio feeds associated with the input content to determine significant scenes; extracting, via the content recognition engine, data from the input content associated with the significant scenes; identifying and tagging, via a key moments extraction module, key moments in the significant scenes in the input content; compiling, via a summary generation engine, a summary recap using tagged key moments associated with the significant scenes; customizing, via the personalization module, the summary recap based on user data collected from user input while viewing the input content; and outputting, via a delivery system, the customized summary recap to the user.

In one or more embodiments of the method for customized smart memory recap for viewed content, the content is one or more of live broadcast content, streaming content, or content stored on a digital video recording (DVR) system. In another aspect of some embodiments, the method further includes: enabling access, via a user interaction layer on a presentation platform, to the customized summary recap, wherein the user interaction layer is within the DVR/streaming service system. In still another aspect of some embodiments, the presentation platform supports multi-platform delivery that enables multi-device accessibility of the customized summary recap across devices that include smartphones, tablets, and televisions. In yet another aspect of some embodiments, the customized summary recap is accessed using the user interaction layer from one or more of a streaming service menu or a standalone notification within a DVR interface.

In some embodiments of the method for customized smart memory recap for viewed content, the input content is processed in real-time to generate minimal latency. In another aspect of some embodiments, the identifying of key moments in the significant scenes in the input content employs different analysis techniques for different types of input content and different complexity of input content. In still another aspect of some embodiments, the summary generation engine and personalization module are continuously learning and updating using Artificial Intelligence, in response to changing user data and user input while viewing the input content. In yet another aspect of some embodiments, the method further includes: sending a notification to a user when a new customized summary recap is available.

In other embodiments, a system for customized smart memory recap for viewed content is disclosed. The system includes a memory that stores computer-executable instructions; and a processor that executes the computer-executable instructions that cause the processor to: receive input content into the system through integration with a content delivery system; process, via a content recognition engine, one or more of metadata, captions, and video/audio feeds associated with the input content to determine significant scenes; extract, via the content recognition engine, data from the input content associated with the significant scenes; identify and tag, via a key moments extraction module, key moments in the significant scenes in the input content; compile, via a summary generation engine, a summary recap using tagged key moments associated with the significant scenes; customize, via the personalization module, the summary recap based on user data collected from user input while viewing the input content; and output, via a delivery system, the customized summary recap to the user.

In one or more embodiments of the system for customized smart memory recap for viewed content, the content is one or more of live broadcast content, streaming content, or content stored on a digital video recording (DVR) system. In another aspect of some embodiments, the system enables access, via a user interaction layer on a presentation platform, to the customized summary recap, and wherein the user interaction layer is within the DVR/streaming service system. In still another aspect of some embodiments, the presentation platform supports multi-platform delivery that enables multi-device accessibility of the customized summary recap across devices that include smartphones, tablets, and televisions. In yet another aspect of some embodiments, the customized summary recap is accessed using the user interaction layer from one or more of a streaming service menu or a standalone notification within a DVR interface.

In some embodiments of the system for customized smart memory recap for viewed content, the input content is processed in real-time to generate minimal latency. In another aspect of some embodiments, the identifying of key moments in the significant scenes in the input content employs different analysis techniques for different types of input content and different complexity of input content. In still another aspect of some embodiments, the summary generation engine and personalization module are continuously learning and updating using Artificial Intelligence, in response to changing user data and user input while viewing the input content. In yet another aspect of some embodiments, the system sends a notification to a user when a new customized summary recap is available.

Moreover, in still other embodiments, one or more non-transitory computer-readable storage mediums are disclosed. The one or more non-transitory computer-readable storage mediums have computer-executable instructions stored thereon that, when executed by a processor, cause the processor to: receive input content into the system through integration with a content delivery system; process, via a content recognition engine, one or more of metadata, captions, and video/audio feeds associated with the input content to determine significant scenes; extract, via the content recognition engine, data from the input content associated with the significant scenes; identify and tag, via a key moments extraction module, key moments in the significant scenes in the input content; compile, via a summary generation engine, a summary recap using tagged key moments associated with the significant scenes; customize, via the personalization module, the summary recap based on user data collected from user input while viewing the input content; and output, via a delivery system, the customized summary recap to the user.

In another aspect of some embodiments, the summary generation engine and personalization module are continuously learning and updating using Artificial Intelligence, in response to changing user data and user input while viewing the input content.

### BRIEF DESCRIPTION OF THE SEVERAL VIEWS OF THE DRAWINGS

The components in the drawings are not necessarily to scale relative to each other. Like reference numerals designate corresponding parts throughout the several views.

FIG. 1 shows a computer architecture and operational flow for a smart memory recap system for watched DVR and live content, according to one example embodiment.

FIG. 2 shows a startup menu screen for a DVR/streaming service platform that employes a system for smart memory recap for watched DVR and live content, with customized summary recaps available for viewing.

FIG. 3 is a logic diagram showing operations flow for a smart memory recap system for watched DVR and live content.

FIG. 4 shows a system diagram that describes an example implementation of a computing system(s) for implementing embodiments described herein.

### DETAILED DESCRIPTION

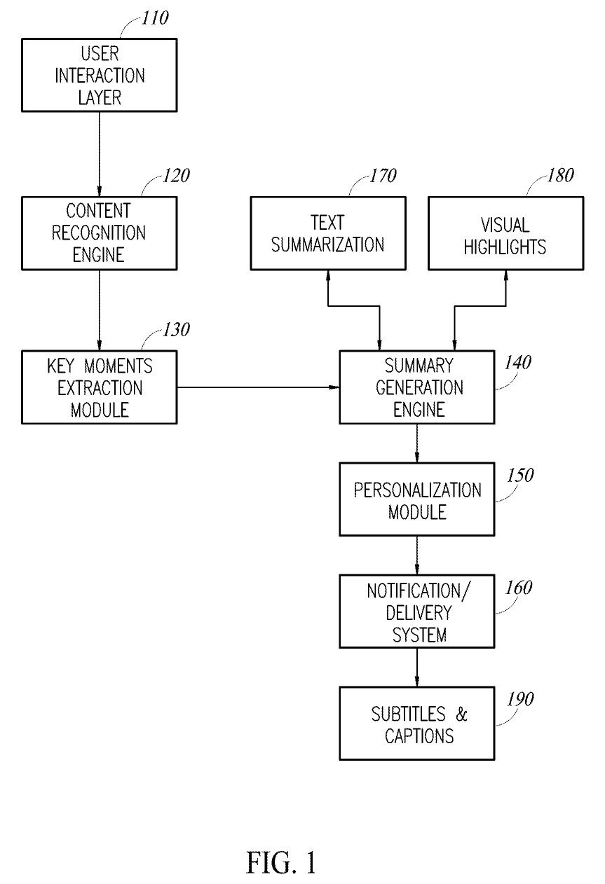

Each of the features and teachings disclosed herein may be utilized separately or in conjunction with other features and teachings to provide a system for smart memory recap for watched DVR/live content. Representative examples utilizing many of these additional features and teachings, both separately and in combination, are described in further detail with reference to the attached FIGS. 1-4. This detailed description is intended to teach a person of skill in the art further details for practicing aspects of the present teachings and is not intended to limit the scope of the claims. Therefore, combinations of features disclosed in the detailed description may not be necessary to practice the teachings in the broadest sense, and are instead taught merely to describe particularly representative examples of the present teachings. In some embodiments, the smart memory recap for watched DVR/live content includes an application program interface that enables users to control certain customer service activities with respect to live broadcast, recorded, streaming and on-demand programming using vocal commands in a customer service control system.

The following description, along with the accompanying drawings, sets forth certain specific details to provide a thorough understanding of various disclosed embodiments. However, one skilled in the relevant art will recognize that the disclosed embodiments may be practiced in various combinations, without one or more of these specific details, or with other methods, components, devices, materials, and the like. In other instances, well-known structures or components that are associated with the environment of the present disclosure, including but not limited to the communication systems and networks, have not been shown or described to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

In some embodiments, the smart memory recap for watched DVR/live content overcomes many technologic challenges and provides many technical improvements, such as reducing latency, increasing content accessibility, improving customization, improving accessibility for users with disabilities, increasing engagement and retention, enhancing subtitles and captions, providing enhanced visual cues, providing enhanced sign language integration, and providing advanced summarization.

The current system provides smart memory recap for watched DVR/live content, thereby reducing duplication presentation latencies. In this manner, the smart memory recap for watched DVR/live content contributes to an improved operational experience by providing customized content summaries of the most significant moments in the viewed shows or events. Additionally, the smart memory recap system may also serve as a content discovery tool, and assist with identifying related content or discover new shows or channels based on analysis of view selection, input, and preferences. In another aspect of some embodiments, the smart memory recap system may be used to create summaries for viewer that do not have the time to watch entire programs but still want to stay informed about the content (e.g., a viewer only has 15 minutes available for viewing, but there is 20 minutes worth of content). In one such embodiment, a user may want to start watching a television series two of three seasons into the series, and only want a recap of the previous seasons, without having to watch the entire seasons.

For long-running series or shows with intricate plots, a smart memory recap system generates a customized summary recap that serves as a memory aid, helping users remember key storylines and characters, which is particularly valuable for shows with complex narratives or extensive character development. Additionally, the smart memory recap system presents users with engaging highlights of viewed shows, thereby encouraging increased viewer engagement and retention. In this manner, viewer retention may be increased if the viewers are reminded of the most compelling moments in shows that they have watched. Moreover, users can easily share their customized summary recap (that have interesting highlights or summaries) with friends and family, via social media platforms or within the same streaming service, thus increasing customer engagement and attraction.

Referring to FIG. 1, the system and method for smart memory recap for watched DVR/live content also obtains and establishes many user attributes at the beginning of a session. In various embodiments, the system and method for smart memory recap for watched DVR/live content is a utility which will provide in-app short video overviews of live or DVR-recorded content. It works by analyzing the key moments of the video, allowing the user to quickly rewatch highlights or important segments without going through the entire recording.

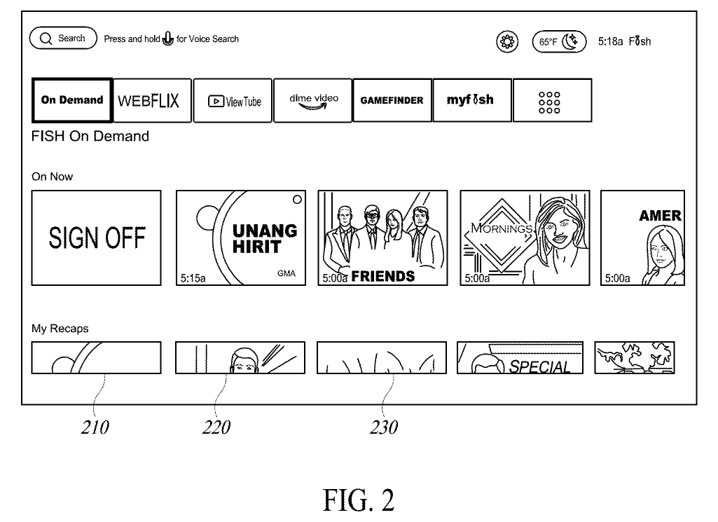

Referring again to FIG. 1, a high-level architecture overview is shown that outlines the key components and operational flow to implement a system and method for smart memory recap for watched DVR/live content. The smart memory recap system is capable of delivering personalized, concise content recaps to enhance the user experience. FIG. 1 visually represents the main components and how they interact with each other through data flow. Each block corresponds to a key component in the system, and the arrows indicate the flow of data between these components. These key components include a user interaction layer 110, a content recognition engine 120, a key moments extraction module 130, a summary generation engine 140, a personalization module 150, and a recap delivery system 160, as well as text summaries 170, visual highlights 180, and subtitle and caption excerpts 190. Notably, the user interaction layer 110 is the interface within the DVR/streaming service platform (see FIG. 2) through which users can access customized summary recaps after they have been sent by the recap delivery system 160.

As shown in FIG. 1, the content recognition engine 120 is the core component of the system for smart memory recap that performs content recognition and analysis. In the environment disclosed herein, content is defined as one or more of live broadcast content, streaming content, or content stored on a digital video recording (DVR) system. The content recognition engine 120 analyzes and processes metadata, captions, titles, descriptions, timestamps, and video/audio feeds associated with the input content to determine significant scenes. The input content is processed in real-time to generate minimal latency. In some embodiments of the smart memory recap system, the content recognition engine 120 performs transcript text analysis on the closed captions to identify key dialogues and events for the summary recap. Additionally, some embodiments of the smart memory recap system, the content recognition engine 120 includes an Artificial Intelligence (AI) Engine that it uses for image and audio recognition to detect important visual scenes or sounds, (e.g., goals in sports, applause in a game show, etc.). Furthermore, in another aspect of some embodiments, the content recognition engine 120 integrates with both recorded content from DVR and live broadcast feeds to ensure comprehensive analysis. Notably, the smart memory recap system extracts data from the input content associated with the significant scenes.

In some embodiments of the system for smart memory recap for watched DVR/live content, the AI Engine is embedded in an Integrated Circuit (IC) chip. In other embodiments of the system for smart memory recap for watched DVR/live content, the AI Engine is cloud based software. In still other of the system for smart memory recap for watched DVR/live content, the AI Engine is a combination of embedded AI and cloud-based AI.

Referring now to another component of the system for smart memory recap shown in FIG. 1, the key moments extraction module 130 identifies and tags key moments in the significant scenes in the input content. Additionally, the key moments extraction module 130 utilizes event detection algorithms to detect significant events, such as plot twists, high-intensity scenes, and crucial game plays. Further, the key moments extraction module 130 breaks down the input content into scenes, and assigns importance scores to the scenes based on various factors, such as dialogue intensity, scene changes, volume changes, resolution changes, or user-defined criteria that has been input. Additional user defined input includes user actions taken while viewing the input content, including by way of example only, and not by way of limitation: skip backward (signifying increased user interest), skip forward (signifying reduced user interest), pauses (signifying increased user interest), slow-motion (signifying increased user interest), fast forward (signifying reduced user interest), reverse (signifying increased user interest). In some embodiments, other user defined criteria includes user preference requests for the summary recaps, such as low-violence, low sexually explicit content, family friendly language, high action, high “cliff-hanger” content, high “cliff-hanger” resolution content, and the like

Moreover, in some embodiments of the system for smart memory recap, the key moments extraction module 130 also tags these key moments with metadata for quick retrieval and use in summary generation. Notably, depending on the type and complexity of input content, the criteria for the identifying of key moments in the significant scenes in the input content employs different analysis techniques. For example, a first AI Engine trained module may be employed when a sporting event has been identified, while second AI Engine trained module may be employed when a romantic comedy series has been identified, and a third AI Engine trained module may be employed when an action/thriller series has been identified.

Referring now to another component of the system for smart memory recap shown in FIG. 1, the summary generation engine 140 creates and compiles a summary recap using tagged key moments associated with the significant scenes. The summary generation engine 140 generates the summary recap by stitching together key moments based on importance scores. These key moments include one or more of audio segments, still photo screen shots, short video clips (e.g., 2-5 seconds) and combinations thereof. In some embodiments, additional text or audio is provide for users with visual or auditory impairments, as dictated by the particular impairments. The summary recap created by the summary generation engine 140 includes extracts and summarizes of important dialogues in some embodiments, thereby ensuring that the narrative flow is maintained in the recap for the user. Additionally, in some embodiments the summary recap created by the summary generation engine 140 includes plot summarization for story-driven content. The plot summarization creates a brief yet coherent narrative covering main plot points. Moreover, for other embodiments, the summary generation engine 140 creates a highlight reel for events like sports. Such a generated highlight reel focuses on critical plays and scores in the sporting event.

Still another component of the system for smart memory recap shown in FIG. 1 is the Personalization Module 150. The Personalization Module 150 customizes the summary recap based on user data collected from user input while viewing the input content, thereby adapting summary recaps to individual user preferences. Specifically, the Personalization Module 150 learns user preferences by tracking user interactions and selection input in order to customize the summary recap. In some embodiments, the Personalization Module 150 uses behavioral analytics that include data on what types of content (e.g., genres, specific scenes) the user watches most frequently to adjust the emphasis in the recap. In another aspect of some embodiments, the Personalization Module 150 use adaptive recap customization to dynamically alter the content of the summary recap to fit the user’s interests. Such adaptive recap customization may include focusing more on action scenes for an action genre fan, focusing more on key discovery scenes for a mystery genre fan, or focusing more on romance scenes for a romance genre fan. Notably, in some embodiments of the system for smart memory recap, one or more of the summary generation engine 140 and personalization module 150 are continuous learning and updating using an Artificial Intelligence Engine, in response to continuous retraining by new user data and user input obtained while the user was viewing the input content.

Referring now to another component of the system for smart memory recap shown in FIG. 1, the notification and delivery system 160 distributes the customized summary recap to the user. In some embodiments, the notification and delivery system 160 sends alerts to users (e.g., via smart phone, computer, and television platform) when a new recap is available. In other embodiments, alerts are not sent to the user, but the user is able to check the user interaction layer 110 on the DVR/Live programming presentation platform (see FIG. 2) to see when a new summary recap has arrived.

Referring now to FIG. 2, a standard startup menu screen with the On Demand selection highlighted in the top row of the startup menu. The customized summary recaps are accessible from within the DVR interface, streaming service menus, or as standalone notifications. In some embodiments, the notification and delivery system 160 enables multi-platform delivery, which ensures that customized summary recaps are accessible across devices such as smartphones, tablets, computers, and televisions. The customized summary recaps, such as the customized summary recaps 210, 220, and 230 are then accessed using the user interaction layer from one or more of within a DVR interface, a streaming service menu, or a standalone notification.

Referring again to FIG. 1, in still other aspect of some embodiments, the smart memory recap system provides enhanced accessibility for users with disabilities. For example, smart memory recap system provides benefits to users with visual or auditory impairments by providing them with concise summaries of content they may have missed due to their visual or auditory impairments. For example, in one embodiment of the smart memory recap system, the text summaries module 170, generates text-based summaries of key moments for hearing-impaired users that cannot otherwise follow the audio portion of the content.

Furthermore, in another aspect of one embodiment the smart memory recap system, the visual highlights module 180 generates a customized summary recap of visual cues or other visually significant moments (e.g., facial expressions, action sequences, or scene changes) that do not rely on audio cues. Such customized summary recaps are more understandable for those who rely on visual information. Moreover, in yet other aspect of some embodiments, the smart memory recap system provides sign language integration with sign language translation services, thereby providing customized summary recaps that include sign language interpretation of key moments, which delivers a more inclusive experience.

In yet another aspect of one embodiment the smart memory recap system, the subtitle and caption excerpts 190 generates summaries of subtitles or captions. Such summaries, which include subtitles or captions, are generated from the key moments of content. In one or more embodiments, these summaries further include textual consolidations of important dialogues, plot points, and event descriptions that are presented in readable text format.

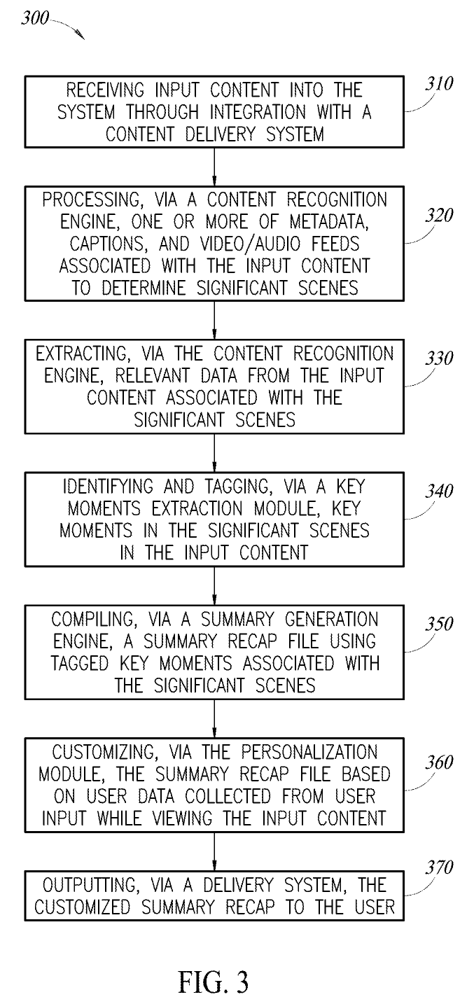

FIG. 3 is a logic diagram 300 showing a method for smart memory recap for watched DVR/live content. As shown in FIG. 3, at operation 310, the method includes receiving input content into the system through integration with a content delivery system. At operation 320, the method includes processing, via a content recognition engine, one or more of metadata, captions, and video/audio feeds associated with the input content to determine significant scenes. At operation 330, the method includes extracting, via the content recognition engine, data from the input content associated with the significant scenes. At operation 340, the method includes identifying and tagging, via a key moments extraction module, key moments in the significant scenes in the input content. At operation 350, the method includes compiling, via a summary generation engine, a summary recap using tagged key moments associated with the significant scenes. At operation 360, the method includes customizing, via the personalization module, the summary recap based on user data collected from user input while viewing the input content. At operation 370, the method includes outputting, via a delivery system, the customized summary recap to the user.

Embodiments of the system and method for smart memory recap for watched DVR/live content have been described above that implement a machine learning model. While many embodiments of the system and method for smart memory recap implement a machine learning model, other embodiments of the system and method for smart memory recap do not employ a machine learning model, but rather utilize more traditional analysis (i.e., non-machine learning). There may be several technical reasons to implement traditional, non-machine learning, analysis, including by way of example only, and not by way of limitation: lack of sufficient computation power available, an insufficient amount of data to properly train a machine learning model, lack of authorization to use the data in a machine learning model (e.g., potentially due to contractual or privacy issues), or the like. Thus, the smart memory recap may be identified using other types of analysis (i.e., non-machine learning) of the user data in one or more embodiments of the system and method for smart memory recap.

In the content distribution environment, audio, video, and/or data service providers, such as television service providers, provide their customers a multitude of video and/or data programming (herein, collectively “programming”). Such programming is often provided by use of a receiving device (e.g., in some embodiments referred to as a hopper) communicatively coupled to a presentation device configured to receive the programming. In one or more embodiments, the receiving device is dynamically controlled by the system and method for smart memory recap for watched DVR/live content. The programming may include any type of media content, including, but not limited to: television shows, news, movies, sporting events, advertisements, etc. In various embodiments, any of this programming may be provided as a type of programming referred to as streaming media content, which is generally digital multimedia data that is substantially constantly received by and presented to an end-user or presented on a device while being delivered by a provider from a stored file source. Its verb form, “to stream,” refers to the process of delivering media in this manner. The term refers to how the media is delivered rather than the media itself.

Examples of a receiving device may include, but are not limited to, devices such as, or any combination of: a “television converter,” “receiver,” “set-top box,” “television receiving device,” “television receiver,” “television,” “television recording device,” “satellite set-top box,” “satellite receiver,” “cable set-top box,” “cable receiver,” “media player,” “digital video recorder (DVR),” “digital versatile disk (DVD) Player,” “computer,” “mobile device,” “tablet computer,” “smart phone,” “MP3 Player,” “handheld computer,” and/or “television tuner,” etc. Accordingly, the receiving device may be any suitable converter device or electronic equipment that is operable to receive programming via a connection to a satellite or cable television service provider outside the customer premises and communicate that programming to another device over a network. Further, the receiving device may itself include user interface devices, such as buttons or switches. In some example embodiments, the receiving device may be configured to receive and decrypt content according to various digital rights management (DRM) and other access control technologies and architectures.

Examples of a presentation device may include, but are not limited to, one or a combination of the following: a television (“TV”), a personal computer (“PC”), a sound system receiver, a digital video recorder (“DVR”), a compact disk (“CD”) device, DVD Player, game system, tablet device, smart phone, mobile device or other computing device or media player, and the like. Presentation devices employ a display, one or more speakers, and/or other output devices to communicate video and/or audio content to a user. In many implementations, one or more presentation devices reside in or near a customer’s premises and are communicatively coupled, directly or indirectly, to the receiving device. Further, the receiving device and the presentation device may be integrated into a single device. Such a single device may have the above-described functionality of the receiving device and the presentation device, or may even have additional functionality.

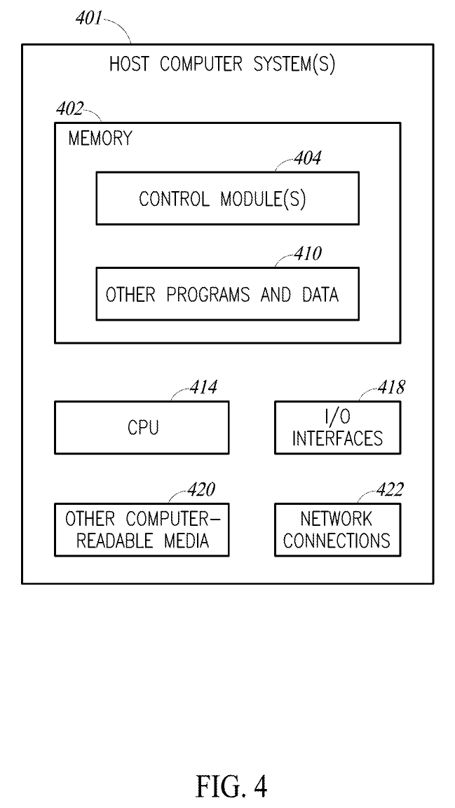

FIG. 4 shows a system diagram that describes an example implementation of a computing system(s) for implementing embodiments described herein. The functionality described herein for a system and method for smart memory recap for watched DVR/live content, can be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that it is agnostic to the underlying cloud infrastructure, allowing higher deployment agility and flexibility.

In particular, shown is example host computer system(s) 401. For example, such computer system(s) 401 may represent those in various data centers and cell sites shown and/or described herein that host the functions, components, microservices and other aspects described herein to implement a system and method for smart memory recap for watched DVR/live content. In some embodiments, one or more special-purpose computing systems may be used to implement the functionality described herein. Accordingly, various embodiments described herein may be implemented in software, hardware, firmware, or in some combination thereof. Host computer system(s) 401 may include memory 402, one or more central processing units (CPUs) 414, I/O interfaces 418, other computer-readable media 420, and network connections 422.

Memory 402 may include one or more various types of non-volatile and/or volatile storage technologies. Examples of memory 402 may include, but are not limited to, flash memory, hard disk drives, optical drives, solid-state drives, various types of random-access memory (RAM), various types of read-only memory (ROM), other computer-readable storage media (also referred to as processor-readable storage media), or the like, or any combination thereof. Memory 402 may be utilized to store information, including computer-readable instructions that are utilized by CPU 414 to perform actions, including those of embodiments described herein.

Memory 402 may have stored thereon control module(s) 404. The control module(s) 404 may be configured to implement and/or perform some or all of the functions of the systems, components and modules described herein for a system and method for smart memory recap for watched DVR/live content. Memory 402 may also store other programs and data 410, which may include rules, databases, application programming interfaces (APIs), software platforms, cloud computing service software, network management software, network orchestrator software, network functions (NF), AI or ML programs or models to perform the functionality described herein, user interfaces, operating systems, other network management functions, other NFs, etc.

Network connections 422 are configured to communicate with other computing devices to facilitate the functionality described herein. In various embodiments, the network connections 422 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 418 may include a video interface, other data input or output interfaces, or the like. Other computer-readable media 420 may include other types of stationary or removable computer-readable media, such as removable flash drives, external hard drives, or the like.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for customized smart memory recap, the method comprising:
receiving input content into a system through integration with a content delivery system;
processing one or more of metadata, captions, and video/audio feeds associated with the input content to determine significant scenes;
extracting data from the input content associated with the significant scenes;
identifying and tagging key moments in the significant scenes in the input content;
compiling a summary recap using tagged key moments associated with the significant scenes;
customizing the summary recap based on user data collected from user input while viewing the input content; and
outputting the customized summary recap to the user.

2. The method of claim 1, wherein the content is one or more of live broadcast content, streaming content, or content stored on a digital video recording (DVR) system.

3. The method of claim 2, further comprising:
enabling access, via a user interaction layer on a presentation platform, to the customized summary recap, wherein the user interaction layer is within the DVR/streaming service system.

4. The method of claim 3, wherein the presentation platform supports multi-platform delivery that enables multi-device accessibility of the customized summary recap across devices that include smartphones, tablets, and televisions.

5. The method of claim 3, wherein customized summary recap is accessed using the user interaction layer from one or more of a streaming service menu or a standalone notification within a DVR interface.

6. The method of claim 1, wherein input content is processed in real-time to generate minimal latency.

7. The method of claim 1, wherein the identifying of key moments in the significant scenes in the input content employs different analysis techniques for different types of input content and different complexity of input content.

8. The method of claim 1, wherein the summary generation engine and personalization module are continuously learning and updating, using Artificial Intelligence, in response to changing user data and user input while viewing the input content.

9. The method of claim 1, further comprising:
sending a notification to a user when a new customized summary recap is available.

10. A system comprising:
one or more processors; and
a memory device storing a set of instructions that, when executed by the one or more processors, causes the one or more processors to:
receive input content into the system through integration with a content delivery system;
process, via a content recognition engine, one or more of metadata, captions, and video/audio feeds associated with the input content to determine significant scenes;
extract, via the content recognition engine, data from the input content associated with the significant scenes;
identify and tag, via a key moments extraction module, key moments in the significant scenes in the input content;
compile, via a summary generation engine, a summary recap using tagged key moments associated with the significant scenes;
customize, via a personalization module, the summary recap based on user data collected from user input while viewing the input content, wherein portions of the input content that are included in the summary recap in the customized summary recap are identified and prioritized, at least in part, based on the user data collected from user input while viewing the input content; and
output, via a delivery system, the customized summary recap to the user.

11. The system of claim 10, wherein the content is one or more of live broadcast content, streaming content, or content stored on a digital video recording (DVR) system.

12. The system of claim 11, wherein the system enables access, via a user interaction layer on a presentation platform, to the customized summary recap, and wherein the user interaction layer is within the DVR/streaming service system.

13. The system of claim 12, wherein the presentation platform supports multi-platform delivery that enables multi-device accessibility of the customized summary recap across devices that include smartphones, tablets, and televisions.

14. The system of claim 12, wherein customized summary recap is accessed using the user interaction layer from one or more of a streaming service menu or a standalone notification within a DVR interface.

15. The system of claim 10, wherein input content is processed in real-time to generate minimal latency.

16. The system of claim 10, wherein the identifying of key moments in the significant scenes in the input content employs different analysis techniques for different types of input content and different complexity of input content.

17. The system of claim 10, wherein the summary generation engine and personalization module are continuously learning and updating, using Artificial Intelligence, in response to changing user data and user input while viewing the input content.

18. The system of claim 10, wherein the system sends a notification to a user when a new customized summary recap is available.

19. A non-transitory computer-readable storage medium having computer-executable instructions stored thereon that, when executed by a processor, cause the processor to:
receive input content into a system through integration with a content delivery system;
process one or more of metadata, captions, and video/audio feeds associated with the input content to determine significant scenes;
extract data from the input content associated with the significant scenes;
identify and tag key moments in the significant scenes in the input content;
compile a summary recap using tagged key moments associated with the significant scenes;
customize the summary recap based on user data collected from user input while viewing the input content; and
output the customized summary recap to the user.

20. The non-transitory computer-readable storage medium of claim 19, wherein the summary generation engine and personalization module are continuously learning and updating, using Artificial Intelligence, in response to changing user data and user input while viewing the input content.
